(19) United States
(12) Patent Application Publication
(10) Pub. No.: US 2026/0189837 A1
(43) Pub. Date: Jul. 2, 2026

(54) EARPHONE

(71) Applicant: Merry Electronics(Shenzhen) Co., Ltd., ShenZhen (CN)

(72) Inventors: Chih-Hung Liu, Taichung (TW); Hung-Wei Chen, Taichung (TW); Chun-Hung Chang, Taichung (TW); Cheng Yu Tsai, Taichung (TW)

(73) Assignee: Merry Electronics(Shenzhen) Co., Ltd., ShenZhen (CN)

(21) Appl. No.: 19/044,637

(22) Filed: Feb. 4, 2025

(30) Foreign Application Priority Data
Dec. 27, 2024 (TW) 113151077

(51) Int. Cl. H04R 1/10

(52) U.S. Cl. CPC H04R 1/1016; H04R 1/105

(57) ABSTRACT

An earphone adapted to be worn on an ear is provided. The earphone includes a wearing component and an acoustical component. The wearing component includes a front positioning portion and an acoustic channel. The front positioning portion is located on an extension axis of the wearing component. The acoustical component is connected to the wearing component, and the acoustical component includes an acoustic chamber, and the acoustic chamber is communicated with the acoustic channel. When the earphone is worn on the ear, the front positioning portion is covered by a tragus of the ear and exerts a first positioning force on the tragus, so that the wearing component is positioned in a cavum conchae of the ear. The acoustic channel corresponds to an ear canal of the ear.

### CROSS-REFERENCE TO RELATED APPLICATION

This application claims the priority benefit of Taiwan application serial no. 113151077, filed on Dec. 27, 2024. The entirety of the above-mentioned patent application is hereby incorporated by reference herein and made a part of this specification.

### BACKGROUND

### Technical Field

The disclosure relates to an earphone.

### Description of Related Art

When the modern in-ear earphone is worn on the ear, the support structure of the earphone only slightly rests on the edge of the cavum conchae of the ear, and cannot stably engage with the ear. Therefore, in more vigorous activity scenarios (for example, sports, wearing a hat, arranging hair, etc.), the earphone is prone to falling off the ear due to mistouch or unexpected force, resulting in poor wearing stability of the earphone.

### SUMMARY

The disclosure provides an earphone with improved wearing stability.

The earphone of the disclosure is adapted to be worn on an ear. The earphone includes a wearing component and an acoustical component. The wearing component includes a front positioning portion and an acoustic channel, the front positioning portion is located on an extension axis of the wearing component. The acoustical component is connected to the wearing component, and the acoustical component includes an acoustic chamber. The acoustic chamber is communicated with the acoustic channel. When the earphone is worn on the ear, the front positioning portion is covered by a tragus of the ear and exerts a first positioning force on the tragus, to position the wearing component in a cavum conchae of the ear, with the acoustic channel corresponding to an ear canal of the ear.

Based on the above, when the earphone of the disclosure is worn on the ear, the front positioning portion of the wearing component is shielded by the tragus and applies an active first positioning force to the tragus, so that the wearing component of the earphone may be stably positioned in the cavum conchae of the ear, resulting in improved wearing stability of the earphone. At this time, the acoustic channel of the wearing component corresponds to the ear canal, thereby shortening the distance between the acoustic channel and the ear canal, which in turn reduces the degree of signal energy attenuation when audio from the earphone enters the ear canal, improving the audio experience and audio performance of the earphone.

### BRIEF DESCRIPTION OF THE DRAWINGS

FIG. 1 is a schematic view of an earphone according to an embodiment of the disclosure worn on an ear.

FIG. 2 is a cross-sectional view of the earphone of FIG. 1 worn on the ear.

FIG. 3 is a schematic view of the earphone of FIG. 1.

FIG. 4 is an exploded view of the earphone of FIG. 3.

### DESCRIPTION OF THE EMBODIMENTS

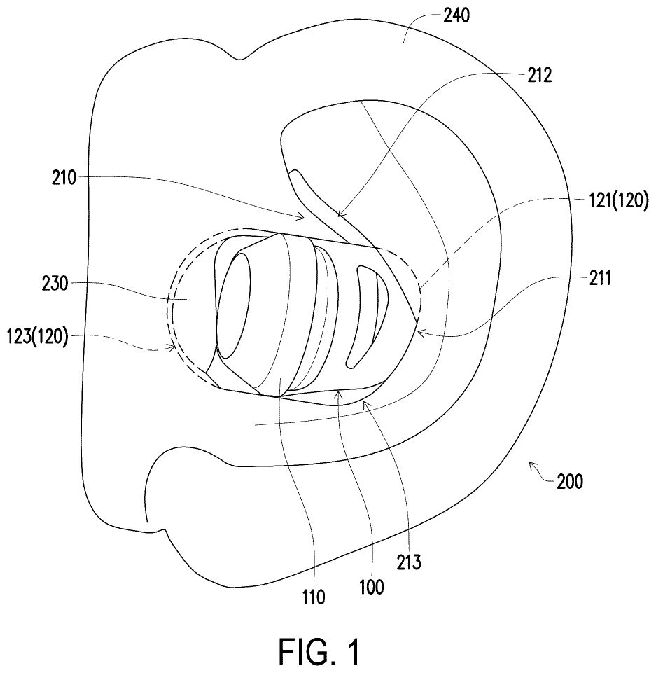

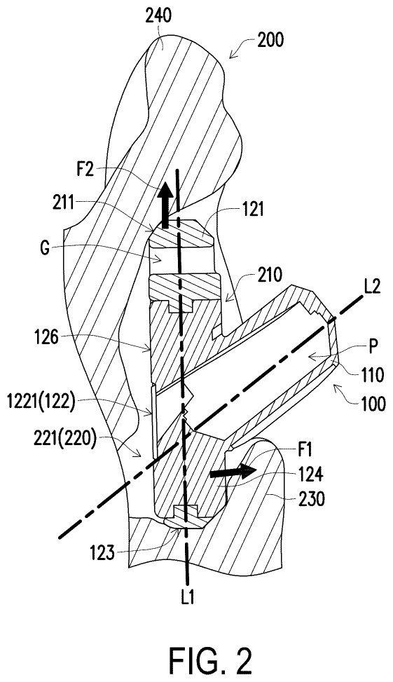

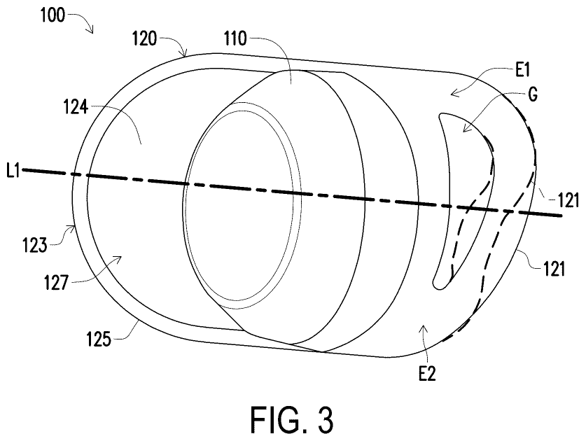

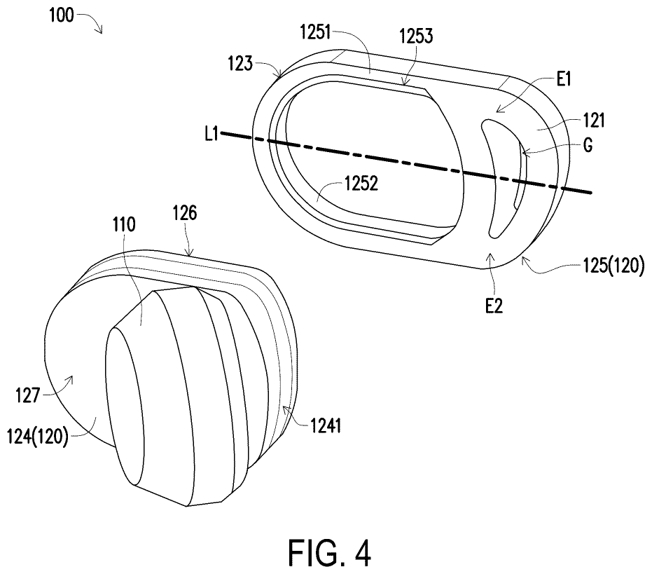

FIG. 1 is a schematic view of an earphone according to an embodiment of the disclosure worn on an ear. FIG. 2 is a cross-sectional view of the earphone of FIG. 1 worn on the ear. FIG. 3 is a schematic view of the earphone of FIG. 1. FIG. 4 is an exploded view of the earphone of FIG. 3. Please refer to FIG. 1 to FIG. 4 at the same time, the earphone 100 may be worn on an ear 200. The earphone 100 includes an acoustical component 110 and a wearing component 120. The acoustical component 110 is connected to the wearing component 120. The wearing component 120 includes a front positioning portion 123 and an acoustic channel 122, the front positioning portion 123 is located on an extension axis L1 of the wearing component 120. The acoustical component 110 includes an acoustic chamber P, and the acoustic chamber P is communicated with the acoustic channel 122. A plurality of acoustic elements and a plurality of electronic components (not shown) may be disposed within the acoustic chamber P.

The cavum conchae 210 of the ear 200 includes a cymba conchae 212, a rear edge 211, and a bottom edge 213. The rear edge 211 is connected between the cymba conchae 212 and the bottom edge 213 and faced to a tragus 230 of the ear 200. The tragus 230 covers an ear canal 220 of the ear 200. When the earphone 100 is worn on the ear 200, the wearing component 120 is positioned within the cavum conchae 210 of the ear 200. The front positioning portion 123 extends into the cavum conchae 210 and is covered by the tragus 230, and exerts a first positioning force F1 on the tragus 230, thereby the wearing component 120 is stably positioned within the cavum conchae 210 of the ear 200, allowing the earphone 100 to be stably connected to the ear 200. The front positioning portion 123 is located between the ear canal 220 and the tragus 230. The direction of the first positioning force F1 may be different from the direction of the extension axis L1.

The support structure of the known earphone is conform to the cymba conchae 212 or the bottom edge 213 of the cavum conchae 210, passively relying on the ear 200. Therefore, when the known earphone is mistouched or subjected to the unexpected force, the known earphone may easily fall off from the ear 200 and lack stability. The support structure of the known earphone needs to form a specially protruding structure to conform with the cymba conchae 212 or the bottom edge 213, thereby increasing the volume of the earphone, making the earphone inconvenient for storage and wearing. The known earphone may also engage with a helix 240 of the ear 200 through a structure such as an ear hook, further increasing the volume of the earphone.

As shown in FIG. 2, when the earphone 100 of this embodiment is worn on the ear 200, the front positioning portion 123 of the earphone 100 pushes against the tragus 230, exerting the active first positioning force F1 to the ear 200, thereby actively relying on the ear 200. Thereby, the earphone 100 is stably positioned within the ear 200 and will not leave the ear 200 due to mistouch or unexpected forces, improving the wearing stability of the earphone 100. The front positioning portion 123 of the earphone 100 is located on the extension axis L1 of the wearing component 120, thereby further reducing the volume of the earphone 100.

The wearing component 120 includes a sound output surface 126. An acoustic sound output hole 1221 of the acoustic channel 122 located on the sound output surface 126. When the earphone 100 is worn on the ear 200, as the wearing component 120 of the earphone 100 extends into the cavum conchae 210, the sound output surface 126 of the earphone 100 faces the ear canal 220, so that the acoustic channel 122 corresponds to the ear canal 220, and is positioned closer to an ear canal inlet 221 of the ear canal 220. Therefore, a distance between the acoustic channel 122 and the ear canal 220 is reduced, and the degree of the signal energy attenuation of the audio entering the ear canal 220 from the earphone 100 is decreased, to improve the audio experience and the audio performance of the earphone 100.

As shown in FIG. 2 and FIG. 3, the wearing component 120 further includes a rear positioning portion 121. The rear positioning portion 121 is located on the extension axis L1 of the wearing component 120, but not limited thereto. When the earphone 100 is worn on the ear 200, the rear positioning portion 121 exerts a second positioning force F2 on the rear edge 211 of the cavum conchae 210. The earphone 100 further actively relies on the ear 200 by the rear positioning portion 121, the earphone 100 is more stably connected to the cavum conchae 210 of the ear 200. The second positioning force F2 is parallel to the extension axis L1, but not limited thereto.

As shown in FIG. 4, the wearing component 120 of this embodiment further includes a wearing body 124 and a support component 125 connected to each other, but not limited thereto. The acoustical component 110 is connected to a surface 127 opposite to the sound output surface 126 of the wearing body 124, and the acoustic channel 122 is located in the wearing body 124. The support component 125 includes a support body 1251. The support body 1251 includes a connecting opening 1253 and a protrusion 1252. The wearing body 124 includes a slot 1241. The protrusion 1252 extends from an edge of the connecting opening 1253 towards a center of the support body 1251. The wearing body 124 enters the connecting opening 1253, causing the protrusion 1252 to engage with the slot 1241, thereby connecting the support component 125 (the support body 1251) to the wearing body 124.

The front positioning portion 123 is located on one side of the support body 1251 and has an arc shape, but not limited thereto. Two ends E1, E2 of the rear positioning portion 121 are connected to the other side of the support body 1251, forming a hollow structure G between the rear positioning portion 121 and the support body 1251. In this embodiment, the material of the support component 125 is a soft material, and the support body 1251 and the rear positioning portion 121 are integrally formed, but not limited thereto.

FIG. 3 illustrates the deformed rear positioning portion 121 with dashed lines. As shown in FIG. 3, since the hollow structure G is located between the rear positioning portion 121 and the support body 1251, when the earphone 100 is worn on the ear 200, the rear positioning portion 121 is pressed and deformed by the cavum conchae 210 to generate a positioning force F, actively relying on the rear edge 211 of the cavum conchae 210. The earphone 100, through the deformation of the rear positioning portion 121, is adapted to be worn on the ears 200 of different shapes, thereby improving the usability of the earphone 100 and enhancing the connection strength between the earphone 100 and the ear 200.

The structure and the material of the rear positioning portion 121 and the front positioning portion 123 are not limited to this embodiment. In an embodiment not shown, there may not be a hollow structure G between the rear positioning portion 121 and the support body 1251, the rear positioning portion 121 may still exert the second positioning force F2 on the ear 200. In an embodiment not shown, the front positioning portion 123 may have the same structure as the rear positioning portion 121. In an embodiment not shown, the material of the support component 125 may be a non-soft material. In this embodiment, the extension axis L2 of the acoustical component 110 is different from the extension axis L1 of the wearing component 120, causing the acoustical component 110 to be inclinedly connected to the wearing component 120, but not limited thereto. The earphone 100 may be a true wireless stereo (TWS) earphone, and may be an open-type earphone, but not limited thereto. The earphone 100 may include an environmental sound channel (not shown) to transmit the external environmental sound into the ear 200.

In summary, when the earphone of the disclosure is worn on the ear, the front positioning portion of the wearing component is shielded by the tragus and applies an active first positioning force to the tragus, so that the wearing component of the earphone may be stably positioned in the cavum conchae of the ear, resulting in improved wearing stability of the earphone. At this time, the acoustic channel of the wearing component corresponds to the ear canal, thereby shortening the distance between the acoustic channel and the ear canal, which in turn reduces the degree of signal energy attenuation when audio from the earphone enters the ear canal, improving the audio experience and audio performance of the earphone.

What is claimed is:

1. An earphone, adapted to be worn on an ear, the earphone comprising:
A wearing component, comprising a front positioning portion and an acoustic channel, the front positioning portion is located on an extension axis of the wearing component; and
An acoustical component, connected to the wearing component, the acoustical component comprises an acoustic chamber, the acoustic chamber is communicated with the acoustic channel,
When the earphone is worn on the ear, the front positioning portion is covered by a tragus of the ear and exerts a first positioning force on the tragus, to position the wearing component in a cavum conchae of the ear, the acoustic channel corresponds to an ear canal of the ear.

2. The earphone according to claim 1, wherein the wearing component comprises a rear positioning portion, when the earphone is worn on the ear, the rear positioning portion exerts a second positioning force on a rear edge of the cavum conchae.

3. The earphone according to claim 1, wherein the wearing component comprises a wearing body and a support component connected to each other, the acoustic channel is located in the wearing body, and the acoustical component is connected to the wearing body.

4. The earphone according to claim 3, wherein the support component comprises a support body, the wearing component comprises a rear positioning portion, the front positioning portion is located on one side of the support body, two ends of the rear positioning portion are connected to another side of the support body, a hollow structure is formed between the rear positioning portion and the support body, and the support body is connected to the wearing body.

5. The earphone according to claim 1, wherein the wearing component comprises a sound output surface, an acoustic sound output hole of the acoustic channel is located on the sound output surface, when the earphone is worn on the ear, the sound output surface faces the ear canal of the ear.
